(19) United States
(12) Patent Application Publication
(10) Pub. No.: US 2025/0241286 A1
(43) Pub. Date: Jul. 31, 2025

(54) SYSTEM AND METHOD FOR AN AGRICULTURAL VEHICLE

(71) Applicant: CNH Industrial America LLC, New Holland, PA (US)

(72) Inventors: Roy A. Bittner, Reedsville, WI (US); Blaine Schwalbe, Valders, WI (US); Gordon Andersen, Poy Sippi, WI (US)

(21) Appl. No.: 18/428,155

(22) Filed: Jan. 31, 2024

(51) Int. Cl. A01M 7/00

(52) U.S. Cl. CPC A01M 7/0075

(57) ABSTRACT

A system for a boom assembly is provided herein that includes a first strike plate operably coupled with a first boom section, the first strike plate rotatable between a first position and a second position. A first catch operably may be operably coupled with a second boom section. The first strike plate is free of the first catch when the first strike plate is in the first position to define an unlocked position and the first strike plate interacts with the first catch when the first strike plate is in the second position to define a locked position, The first boom section and the second boom section are movable relative to one another. A brace operably may be operably coupled with the first boom section and the first strike plate.

### FIELD

The present disclosure generally relates to agricultural vehicles and, more particularly, to systems and methods for vehicles including a boom assembly.

### BACKGROUND

Various types of agricultural vehicles may utilize applicators (e.g., sprayers, floaters, etc.) to deliver an agricultural product to the ground of a field. The agricultural product may be in the form of a solution or mixture, with a carrier (such as water) being mixed with one or more active ingredients (such as an herbicide, fertilizer, fungicide, a pesticide, or another product).

The applicators may be pulled as an implement or self-propelled and may include a tank, a pump, a boom assembly, and a plurality of nozzles carried by the boom assembly at spaced locations. The boom assembly may include a pair of boom arms, with each boom arm extending to either side of the applicator when in an unfolded state. Each boom arm may include multiple boom sections, each with a number of spray nozzles (also sometimes referred to as spray tips).

During a spray operation, the vehicle drives over a target to direct the agricultural product at the target. However, the various factors may cause sections of the boom arm to move relative to one another. Accordingly, a vehicle that is capable of retaining one boom section relative to another would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to a system for a boom assembly includes a first strike plate operably coupled with a first boom section. The first strike plate is rotatable between a first position and a second position. A first catch is operably coupled with a second boom section. The first strike plate is free of the first catch when the first strike plate is in the first position to define an unlocked position and the first strike plate interacts with the first catch when the first strike plate is in the second position to define a locked position, and wherein the first boom section and the second boom section are movable relative to one another. A brace is operably coupled with the first boom section and the first strike plate.

In some aspects, the present subject matter is directed to a method for an operation of a system for a boom assembly. The method includes receiving, from an input device, instructions to retain a first boom section relative to a second boom section. The method also includes activating, with a computing system, a latch actuator to rotate a strike plate operably coupled with the first boom section from an unlocked position to a locked position, wherein the strike plate interacts with a catch on the second boom section in the locked position.

In some aspects, the present subject matter is directed to a system for a boom assembly includes a first strike plate operably coupled with a first boom section. The first strike plate is rotatable between a first position and a second position. A first catch is operably coupled with a second boom section. The first strike plate is configured to interact with the first catch when the first strike plate is in the second position. A second strike plate is operably coupled with the first boom section. The second strike plate is rotatable between a first position and a second position. A second catch is operably coupled with a second boom section. The second strike plate is configured to interact with the second catch when the second strike plate is in the second position.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a front perspective view of a vehicle in accordance with aspects of the present subject matter;

FIG. 2 illustrates a rear perspective view of the vehicle in accordance with aspects of the present subject matter;

FIG. 3 illustrates a side view of the vehicle in accordance with aspects of the present subject matter;

FIG. 4 illustrates a front perspective view of a portion of a boom assembly in accordance with aspects of the present subject matter;

FIG. 5 illustrates a rear perspective view of a portion of a boom assembly in accordance with aspects of the present subject matter;

FIG. 6 illustrates a side perspective view of a portion of a boom assembly in accordance with aspects of the present subject matter;

FIG. 7 illustrates a schematic diagram of a latch system operably coupled with the boom assembly in accordance with aspects of the present subject matter; and

FIG. 8 illustrates a flow diagram of a method for an operation of the latch system in accordance with aspects of the present subject matter;

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations may be made in the present disclosure without departing from the scope or spirit of the disclosure. For instance, features illustrated or described as part may be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality may be seen as “associated with” each other such that the defined functionality is achieved, irrespective of architectures or intermedial components. Likewise, any two components so associated may also be viewed as being “operably connected” or “operably coupled” to each other to achieve the defined functionality, and any two components capable of being so associated may also be viewed as being “operably couplable” to each other to achieve the defined functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items may be employed by itself, or any combination of two or more of the listed items may be employed. For example, if a composition or assembly is described as containing components A, B, and/or C, the composition or assembly may contain A alone; B alone; C alone; A and B in combination; A and C in combination; B and C in combination; or A, B, and C in combination.

In general, the present subject matter is directed to systems and methods for retaining one boom section relative to another on an agricultural vehicle with a latch assembly. In some examples, the system may include a first strike plate operably coupled with a first boom section. The first strike plate may be rotatable between a first position and a second position. A first catch may be operably coupled with a second boom section. The first strike plate may be configured to interact with the first catch when the first strike plate is in the second position.

A second strike plate may be operably coupled with the first boom section or the second boom section. The second strike plate may be rotatable between a first position and a second position. A second catch may be operably coupled with the opposite of the first boom section or the second boom section from the second strike plate. The second strike plate may be configured to interact with the second catch when the second strike plate is in the second position.

In some cases, a brace may be operably coupled with each of the strike plates and may define a first strike plate portion, a second strike plate portion, and an anchor portion. A position plate may be rotatably coupled with the anchor portion.

A latch actuator may be operably coupled with the position plate and configured to rotate the position plate relative to the brace. A link assembly may include a latch actuator link operably coupled with the latch actuator and the position plate, a first link operably coupled with the position plate and the first strike plate, and a second link operably coupled with the position plate and the second strike plate. The latch actuator may be configured to receive a command to move the latch assembly between the unlocked and locked position, or vice versa. In turn, a computing system may alter a position of the latch actuator.

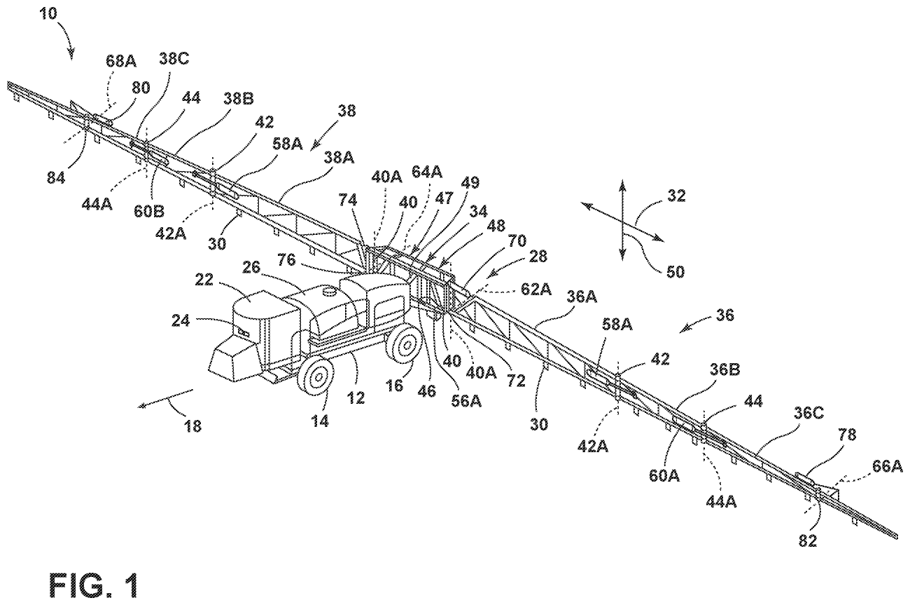

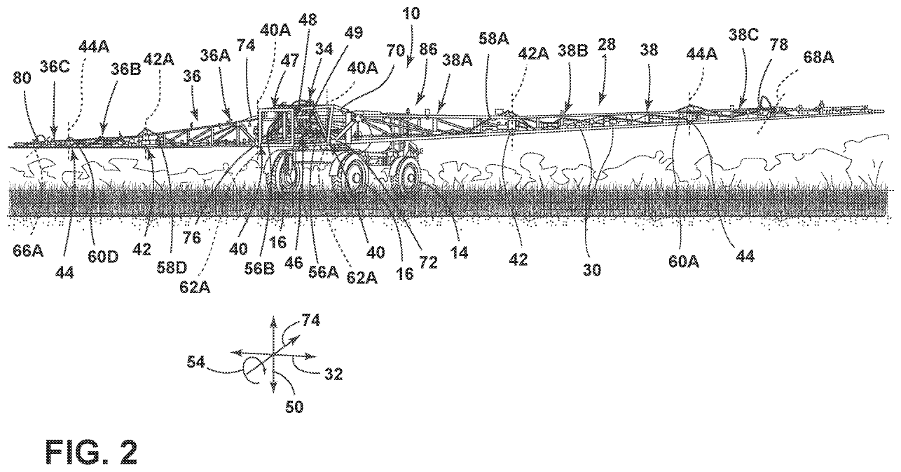

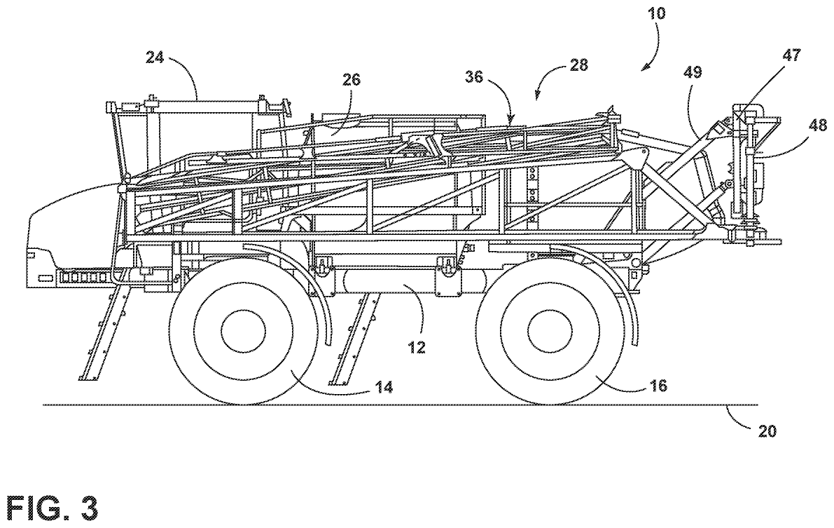

Referring now to FIGS. 1-3, differing views of a vehicle 10 are illustrated in accordance with aspects of the present subject matter. As shown, FIG. 1 illustrates a front perspective view of the vehicle with a boom assembly in a working or unfolded position, FIG. 2 illustrates a rear perspective view of the vehicle with a boom assembly in a working or unfolded position, and FIG. 3 illustrates a side view of the vehicle with a boom assembly in a transport or folded position. In the illustrated examples, the vehicle is configured as a self-propelled vehicle. However, in alternative embodiments, the vehicle may be configured as any other suitable type of vehicle configured to perform agricultural spraying operations, such as a tractor or other vehicle configured to haul a spraying or application implement.

As shown in FIGS. 1 and 2, the vehicle 10 may include a chassis 12 or frame configured to support or couple to a plurality of components. For example, front wheels 14 and rear wheels 16 may be coupled to the chassis 12. The wheels 14, 16 may be configured to support the vehicle 10 relative to the ground 20 and move the vehicle 10 in a direction of travel (e.g., as indicated by arrow 18 in FIG. 1) across the ground 20.

The chassis 12 may also support an operator's cab 22 that houses various control or input devices (e.g., levers, pedals, control panels, buttons, and/or the like) for permitting an operator to control the operation of the work vehicle 10. For instance, as shown in FIG. 1, the vehicle 10 may include a human-machine or user interface 24 for displaying message windows and/or alerts to the operator and/or for allowing the operator to interface with the vehicle's controller or computing system.

Furthermore, the chassis 12 may also support one or more tanks 26, which may be in the form of a product tank and/or an auxiliary tank. Each product tank is generally configured to store or hold an agricultural product, such as a pesticide, an herbicide, a nutrient, and/or the like. The auxiliary tank may be configured to store or hold clean water and/or any other product, which may be different from the agricultural product within the product tank.

The chassis 12 may further support a boom assembly 28 operably mounted to the chassis 12. A plurality of nozzle assemblies 30 are mounted on the boom assembly 28 and configured to selectively dispense the agricultural product stored in the one or more tanks 26 via the nozzle assemblies 30 onto underlying plants and/or soil. The nozzle assemblies 30 are generally spaced apart from each other on the boom assembly 28 along a lateral direction 32. Furthermore, fluid conduits may fluidly couple the nozzle assemblies 30 to the tank(s) 26. Each nozzle assembly 30 may include a nozzle valve and an associated spray tip or spray nozzle. In several embodiments, the operation of each nozzle valve may be individually controlled by an associated controller or computing system such that the valve regulates the flow rate and/or another spray characteristic of the agricultural product through the associated spray nozzle.

As shown in FIGS. 1 and 2, in various embodiments, the boom assembly 28 includes a central boom section 34, a left boom arm 36, and a right boom arm 38. The left boom arm 36 includes a left inner boom section 36A pivotably coupled to the central boom section 34, a left middle boom section 36B pivotably coupled to the left inner boom section 36A, and a left outer boom section 36C pivotably coupled to the left middle boom section 36B. Similarly, the right boom arm 38 includes a right inner boom section 38A pivotably coupled to the central boom section 34, a right middle boom section 38B pivotably coupled to the right inner boom section 38A, and a right outer boom section 38C pivotably coupled to the right middle boom section 38B. Each of the inner boom sections 36A, 38A is pivotably coupled to the central boom section 34 at joints 40. Similarly, the middle boom sections 36B, 38B are pivotally coupled to the respective inner boom sections 36A, 38A at joints 46 while the outer boom sections 36C, 38C are pivotably coupled to the respective middle boom sections 36B, 38B at joints 44.

The joints 40, 42, 44 may be configured to allow relative motion between adjacent boom sections of the boom assembly 28. For example, the joints 40, 42, 44 may allow for articulation of the various boom sections between an extended or working position (e.g., as shown in FIGS. 1 and 2), in which the boom sections are unfolded along the lateral direction 32 to allow for the performance of an agricultural spraying operation, and a transport position (FIG. 3), in which the boom sections are folded inwardly to reduce the overall width of the boom assembly 28 along the lateral direction 32. Although the boom assembly 28 is shown in FIGS. 1-3 as including a central boom section and three individual boom sections coupled to each side of the central boom sections, the boom assembly 28 may generally have any suitable number of boom sections. For example, each boom arm 36, 38 may include four or more boom sections or less than three boom sections.

In some examples, the boom assembly 28 may include a mast 47 coupled to a frame 48 that, in combination, may support the boom assembly 28 relative to the vehicle chassis 12. For example, the frame 48 may be coupled to the mast 47 via a linkage system that is configured to transfer the downward load 52 of the frame 48 to the mast 47. For instance, the weight of the first and second boom arms 36, 38 is supported by the frame 48, and the frame 48 transfers the load to the mast 47 via the linkage system. The mast 47, in turn, transfers the load to the vehicle chassis 12 via the linkage system, thereby suspending the boom assembly 28 above the ground 20. Furthermore, the linkage system may experience rotation of the frame 48 relative to the mast 47 about an axis parallel to the direction of travel 18. For example, if the vehicle 10 tilts to one side due to variations in the terrain, the boom may rotate about the axis, illustrated by rotational line 54.

In various examples, the linkage system may include one or more actuators 49 that is configured to rotate the frame 48 relative to the mast 47, which may be performed to counteract the rotation of the boom assembly 28. Additionally or alternatively, the one or more actuators 49 may be configured to adjust the height of the boom assembly 28 relative to the chassis 12 of the vehicle 10 may be adjusted by one or more actuators 49 operably coupled with the boom assembly 28 and the chassis 12. In some instances, the height may be adjusted along an axis, as generally illustrated by line 50 in FIG. 2.

Additionally, as shown in FIGS. 1 and 2, the boom assembly 28 may include inner fold actuators 56A, 56B coupled between the inner boom sections 36A, 38A and the central boom section 34 to enable pivoting or folding between the fully-extended working position and the transport position. For example, by retracting/extending the inner fold actuators 56A, 56B, the inner boom sections 36A, 38A may be pivoted or folded relative to the central boom section 34 about a pivot axis 40A respectively defined by the joints 40. Moreover, the boom assembly 28 may also include middle fold actuators 58A, 58B coupled between each inner boom section 36A, 38A and its adjacent middle boom section 36B, 38B and outer fold actuators 60A, 60B coupled between each middle boom section 36B, 38B and its adjacent outer boom section 36C, 38C. As such, by retracting/extending the middle and outer fold actuators 58A, 58B, 60A, 60B, each middle and outer boom section 36B, 38B, 36C, 38C may be pivoted or folded relative to its respective inwardly adjacent boom section 36A, 38A, 36B, 38B about a respective pivot axis 42A, 44A.

In various examples, the boom assembly 28 may move relative to one or more yaw-related pivot axes. For instance, the boom assembly 28 may rotate relative to a left yaw axis and/or a right yaw axis, either of which may be affected by one or more of the pivot axes 40A, 42A, 46A. In various instances, the fold actuators 56A, 56B, 58A, 58B, 60A, 60B may be adjusted to mitigate the yaw-related movement.

With further reference to FIGS. 1-3, the boom assembly 28 may additionally or alternatively be configured to move various boom sections relative to one another and/or relative to chassis 12 about a relative roll axis 54. In the illustrated examples, the boom assembly 28 may be affected by the positions of the various sections relative to one another about the roll axis 54 for the central boom section 34, a lift axis 50 for the central boom section 34, the left main shoulder pivot axis 62A, the right main shoulder pivot axis 64A, a left tertiary shoulder pivot axis 66A, and/or a right tertiary shoulder pivot axis 68A.

For example, as shown in FIGS. 1 and 2, a lift actuator 70 may be positioned between the left inner boom section 36A and the central boom section 34. As a result, the lift actuator 70 may be configured to drive rotation of the left inner boom section 36A relative to the central boom section 34 about the roll axis 62A. In some instances, a first rotation assembly 72 is mounted between the left inner boom section 36A and the central boom section 34 and defines the roll axis 62A. As such, the first rotation assembly 72 may be configured to enable rotation of the left inner boom section 36A in response to the actuation of the lift actuator 70.

In addition, a lift actuator 74 may be positioned between the right inner boom section 38A and the central boom section 34. As a result, the lift actuator 74 may be configured to drive rotation of the right inner boom section 38A relative to the central boom section 34 about a roll axis 64A. In some instances, a second rotation assembly 76 is mounted between the right inner boom section 38A and the central boom section 34 and defines the roll axis 64A. As such, the second rotation assembly 76 may be configured to enable rotation of the right inner boom section 38A in response to the actuation of the lift actuator 74.

Further, respective lift actuators 78, 80 may be positioned between each middle boom section 36B, 38B and its adjacent outer boom section 36C, 38C. As a result, the lift actuators 78, 80 may be configured to drive rotation, with respective third and fourth rotation assemblies 82, 84 of each middle boom section 36B, 38B and its adjacent outer boom section 36C, 38C about respective roll axes 54. In some instances, third and fourth rotation assemblies 82, 84 may be respectively mounted between each middle boom section 36B, 38B and its adjacent outer boom section 36C, 38C and respectively define the roll axes 54. As such, the third and fourth rotation assemblies 82, 84 may be configured to enable rotation of each middle boom section 36B, 38B and its adjacent outer boom section 36C, 38C in response to the actuation of the respective lift actuator 78, 80.

In various examples, any of the actuators 56A, 56B, 58A, 58B, 60A, 60B, 70, 74, 78, 80 described herein may be configured as hydraulic cylinders. However, it will be appreciated that different actuators 56A, 56B, 58A, 58B, 60A, 60B, 70, 74, 78, 80 may be used in other examples. For example, any of the actuators 56A, 56B, 58A, 58B, 60A, 60B, 70, 74, 78, 80 may be configured as electric actuators, pneumatic cylinders, pulley systems, and/or any other practicable device.

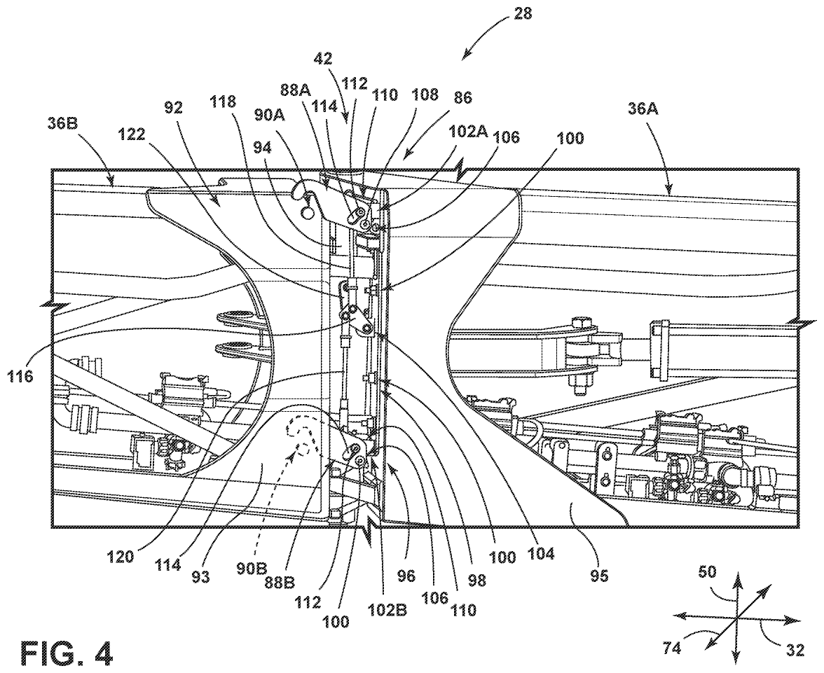

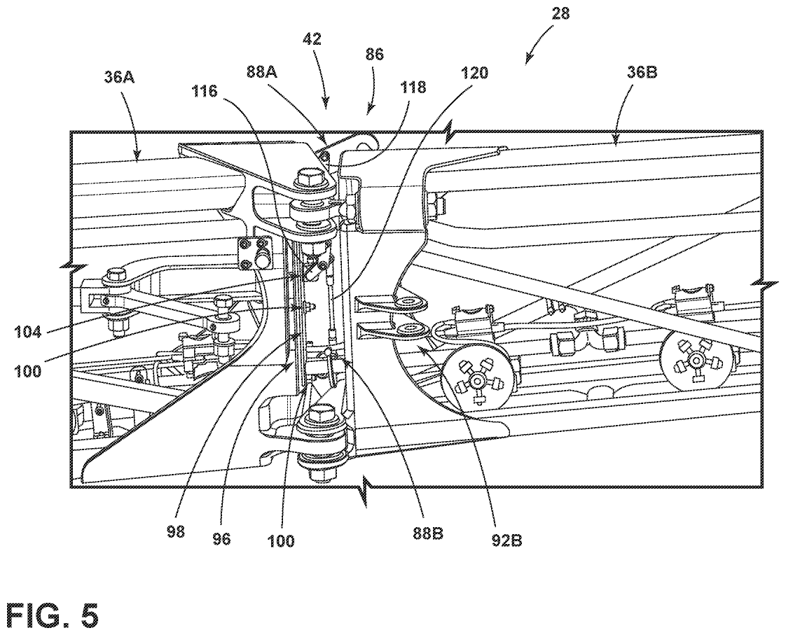

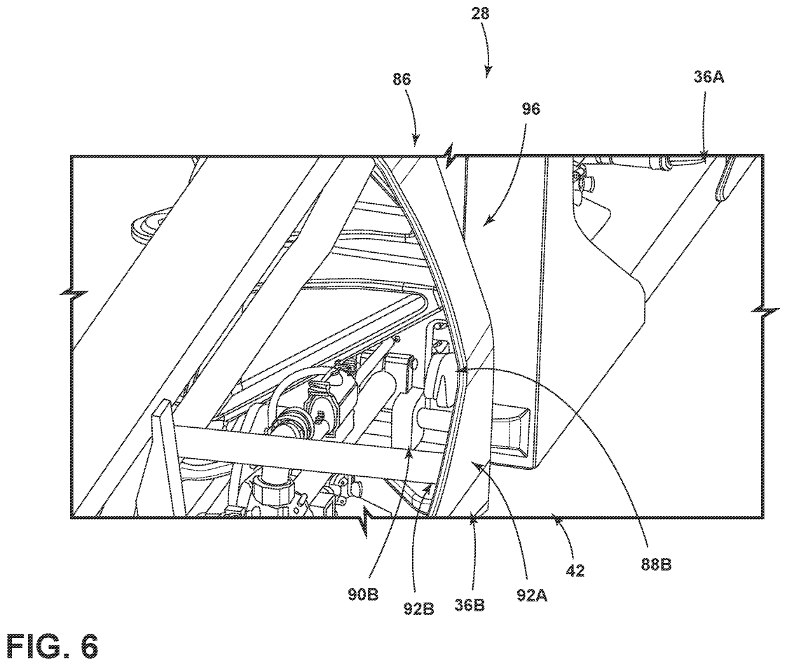

Referring now to FIGS. 4-6, enhanced perspective views of a joint 42 of the boom assembly are illustrated in accordance with various aspects of the present disclosure. As illustrated, a latch system 86 is operably coupled with the boom assembly. In various examples, the latch system 86 may be configured to selectively retain one boom section (e.g., 36A) relative to another boom section (e.g., 36B) and/or any other component of the vehicle.

In the examples illustrated in FIGS. 4-6, the latch system 86 includes one or more strike plates 88A, 88B and one or more corresponding catches 90A, 90B. In the illustrated example, a first strike plate 88A may be operably coupled with a first boom section (e.g., 36A) and a first catch 90A may be positioned on a second boom section (e.g., 36B). The first strike plate 88A may be rotatable between at least a first position and a second position. The first strike plate 88A may be free the first catch 90A to define an unlocked position when the first strike plate 88A is placed in a first position. The first strike plate 88A may interact with the first catch 90A to define a locked position when each of the first boom section (e.g., 36A) and the second boom section (e.g., 36B) are positioned in the extended position and the first strike plate 88A is placed in a second position

Additionally, a second strike plate 88B may be coupled with the first boom section (e.g., 36A) and may be offset (e.g., offset in a vertical direction 50, a fore-aft direction 79, and/or a lateral direction 32) from the first strike plate 88A along the first boom section (e.g., 36A). A second catch 90B may be positioned on the second boom section (e.g., 36B). The second strike plate 88B may be rotatable between at least a first position and a second position. The second strike plate 88B may be free the second catch 90B to define an unlocked position when the second strike plate 88B is placed in a first position. The second strike plate 88B may interact with the second catch 90B to define a locked position when each of the first boom section (e.g., 36A) and the second boom section (e.g., 36B) are positioned in the extended position and the second strike plate 88B is placed in a second position.

The first strike plate 88A may be positioned on the first boom section (e.g., 36A) and the first catch 90A may be positioned on the second boom section (e.g., 36B) or the first strike plate 88A may be positioned on the second boom section (e.g., 36B) and the first catch 90A may be positioned on the first boom section (e.g., 36A) without departing from the scope of the present disclosure. Similarly, the second strike plate 88B may be positioned on the first boom section (e.g., 36A) and the second catch 90B may be positioned on the second boom section (e.g., 36B) or the second strike plate 88B may be positioned on the second boom section (e.g., 36B) and the second catch 90B may be positioned on the first boom section (e.g., 36A) without departing from the scope of the present disclosure.

As illustrated, the first strike plate 88A may be positioned on a first side 92A of an end panel 93 of the second boom section (e.g., 36B) and the second strike plate 88B may be positioned on a second, opposing side 92B of the end panel 93 of the second boom section (e.g., 36B). Alternatively, the first strike plate 88A and the second strike plate 88B may each be positioned on a common side (the first side 92A or the second side 92B) of the end panel 93 of the second boom section (e.g., 36B). Similarly, the first catch 90A may be positioned on a first side of an end panel 95 of the first boom section (e.g., 36A) and the second catch 90B may be positioned on a second, opposing side of the end panel 95 of the first boom section (e.g., 36A). Alternatively, the first catch 90A and the second catch 90B may each be positioned on a common side (the first side 92A or the second side 92B) of the end panel 93 of the second boom section (e.g., 36B).

Referring further to FIGS. 4-6, the latch system 86 may include a latch actuator 94 that is configured to rotate the first strike plate 88A between its respective the first position and the second position and/or the second strike plate 88B between its respective the first position and the second position. The latch actuator 94 may be configured as an electric actuator, a pneumatic cylinder, a pulley system, and/or any other practicable device.

With further reference to FIG. 4, a link assembly 96 may be operably coupled with the first boom section (e.g., 36A), the first strike plate 88A, the second strike plate 88B, and/or the latch actuator 94. The link assembly 96 may be configured to move at least one of the first strike plate 88A between the first position and the second position and/or the second strike plate 88B between the first position and the second position. As illustrated, the link assembly 96 may include a brace 98 that is operably coupled with the first boom section (e.g., 36A), or the second boom section (e.g., 36B). In some cases, the brace 98 may be operably coupled with the first boom section (e.g., 36A) through one or more fasteners 100. The brace 98 may define one or more strike plate portions 102A, 102B and an anchor portion 104. The one or more strike plate portions 102A, 102B may be configured to rotatably support each respective strike plate 88A, 88B of the latch system 86. While shown as a continuous structure, the brace 98 may be configured as any number of components that are capable of accomplishing any one or more of the functions described herein without departing from the scope of the present disclosure.

In various examples, each of the strike plate portions 102A, 102B may include an attachment segment 106, which may define an attachment opening for a pivot pin 108. The pivot pin 108 may be positioned through a void defined by the strike plate 88A, 88B and into the attachment opening to retain the strike plate 88A, 88B. Additionally or alternatively, each of the strike plate portions 102A, 102B may include a guide segment 110, which may define a guide opening for a guide pin 112. The guide pin 112 may be positioned through a channel 114 defined by the strike plate 88A, 88B and into the guide opening to guide the strike plate 88A, 88B as the strike plate 88A, 88B is moved between the first position and the second position.

With further reference to FIGS. 4-6, the link assembly 96 may further include a position plate 116 rotatably coupled with the anchor portion 104 of the brace 98. For instance, the anchor portion 104 may define a retaining opening and the position plate 116 may define a respective retaining void. A first link 118 may be operably coupled with the position plate 116 and the first strike plate 88A. When the position plate 116 is moved from a first position to a second position, or vice versa, the first link 118 causes the first strike plate 88A to also move from its respective first position to its respective second position. Additionally or alternatively, a second link 120 may be operably coupled with the position plate 116 and the second strike plate 88B. When the position plate 116 is moved from a first position to a second position, or vice versa, the second link 120 causes the second strike plate 88B to also move from its respective first position to its respective second position. As such, the position plate 116 may move each of the first strike plate 88A and the second strike plate 88B from a first position to a second position contemporaneously. However, the latch system 86 may include one or more position plates 116 that allow for independent movement of the first strike plate 88A and the second strike plate 88B without departing from the teachings provided herein.

As provided herein, the first strike plate 88A may be offset from the second strike plate 88B in a vertical direction 50, a fore-aft direction 79, and/or a lateral direction 32. Due to the offset positioning of the first strike plate 88A relative to the second strike plate 88B, an attachment location of the first link 118 on the position plate 116 may be offset from an attachment location of the second link 120 on the position plate 116 in a vertical direction, fore-aft direction, and/or a lateral direction. As such, the position plate 116 may have a non-symmetrical shape that is varied based on the design constraints of a defined boom assembly. Moreover, in some cases, a rotational axis of the first strike plate 88A, a rotational axis of the second strike plate 88B, and a rotational axis of the position plate 116 may each be offset from one another in a vertical direction 50, a fore-aft direction 79, and/or a lateral direction 32.

Referring still to FIGS. 4-6, the link assembly 96 may further include an actuator link 122 operably coupled with the latch actuator 94 and the position plate 116. As such, when activated, the latch actuator 94 may rotate the position plate 116 relative to the brace 98. By altering a position of the position plate 116, a position of the first strike plate 88A and/or a position of the second strike plate 88B may also be altered.

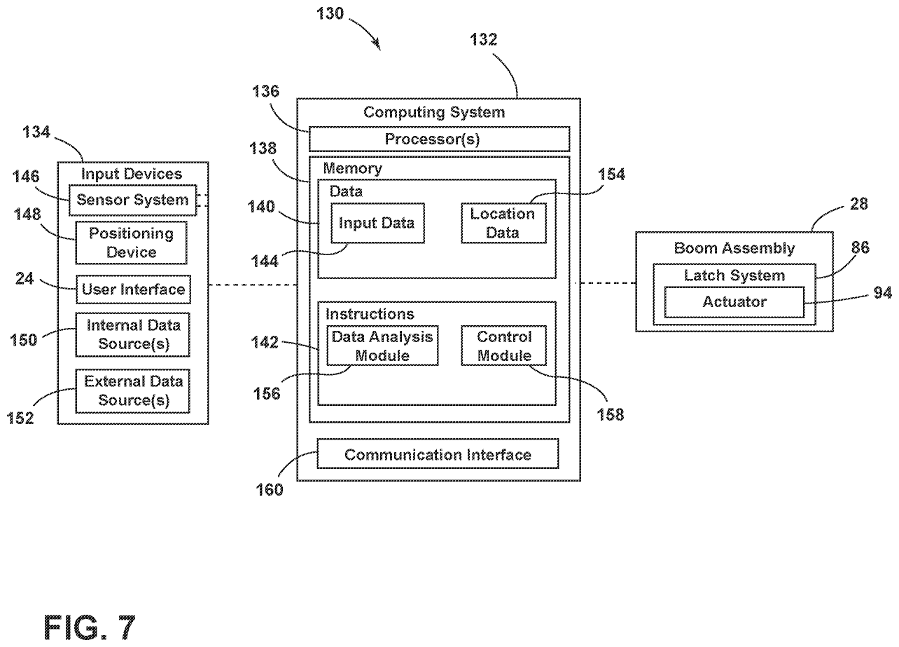

Referring now to FIG. 7, a schematic view of a system 130 for an agricultural vehicle 10 is illustrated in accordance with aspects of the present subject matter. The system 130 will generally be described herein with reference to the agricultural vehicle 10 described above with reference to FIGS. 1-6. However, the disclosed system 130 may generally be utilized with agricultural machines having any other suitable machine configuration.

As shown in FIG. 7, the system 130 may include a computing system 132 operably coupled with various input devices 134 and the latch system 86. In general, the computing system 132 may correspond to any suitable processor-based device(s), such as a computing device or any combination of computing devices. For example, the computing system 132 may generally include one or more processors 136 and one or more associated memory 138 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 138 may generally include memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 138 may generally be configured to store information accessible to the processors 136, including data 140 that may be retrieved, manipulated, created, and/or stored by the processors 136 and instructions 142 that may be executed by the processors 136.

In several examples, the data 140 may be stored in one or more databases. For example, the memory 138 may include an input database 144 for storing input data received from the input devices 134. For example, the input devices 134 may include a sensor system 146, which may include one or more sensors configured to monitor a position of the first boom section (e.g., 36A) and/or the second boom section (e.g., 36B) (or any other data), one or more positioning devices 148 for generating position data associated with the location of the vehicle 10, one or more user interfaces 24 for allowing operator inputs to be provided to the computing system 132 (e.g., buttons, knobs, dials, levers, joysticks, touch screens, and/or the like), one or more other internal data sources 150 associated with the vehicle 10 (e.g., other devices, databases, etc.), one or more external data sources 152 (e.g., a remote computing device or server), and/or any other suitable input devices 134. The data received from the input devices 134 may, for example, be stored within the input database 144 for subsequent processing and/or analysis. It will be appreciated that, in addition to being considered an input devices 134 that allows an operator to provide inputs to the computing system 132, the user interface 24 may also function as an output device. For example, the user interface 24 may be configured to allow the computing system 132 to provide feedback to the operator (e.g., visual feedback via a display or other presentation device, audio feedback via a speaker or other audio output device, and/or the like).

Moreover, in several examples, the memory 138 may also include a location database 154 storing location information about the vehicle 10 and/or information about the ground 20 being processed (e.g., a field map). Such location database 154 may, for example, correspond to a separate database or may form part of the input database 144. As shown in FIG. 7, the computing system 132 may be communicatively coupled to the positioning devices 148 installed on or within the vehicle 10. For example, in some examples, the positioning devices 148 may be configured to determine the location of the vehicle 10 using a satellite navigation position system (e.g., a GPS, a Galileo positioning system, the Global Navigation Satellite System (GLONASS), the BeiDou Satellite Navigation and Positioning system, and/or the like). In such an example, the location determined by the positioning devices 148 may be transmitted to the computing system 132 (e.g., in the form of coordinates) and subsequently stored within the location database 154 for subsequent processing and/or analysis.

Additionally, in several examples, the location data stored within the location database 154 may also be correlated to all or a portion of the input data stored within the input database 144. For instance, in some examples, the location coordinates derived from the positioning devices 148 and the data received from the input devices 134 may both be time-stamped. In such an example, the time-stamped data may allow the data received from the input devices 134 to be matched or correlated to a corresponding set of location coordinates received from the positioning devices 148, thereby allowing the precise location of the portion of the ground 20 associated with the input data to be known (or at least capable of calculation) by the computing system 132.

Moreover, by matching the input data to a corresponding set of location coordinates, the computing system 132 may also be configured to generate or update a corresponding field map associated with the ground 20 being processed. For example, in instances in which the computing system 132 already includes a field map stored within its memory 138 that includes location coordinates associated with various points across the ground 20, the input data received from the input devices 134 may be mapped or correlated to a given location within the field map. Alternatively, based on the location data and the associated image data, the computing system 132 may be configured to generate a field map for the ground 20 that includes the geo-located input data associated therewith.

Referring still to FIG. 7, in several examples, the instructions 142 stored within the memory 138 of the computing system 132 may be executed by the processors 136 to implement a data analysis module 156. In general, the data analysis module 156 may be configured to analyze the input data (e.g., a set of input data received at a given time or within a given time period or a subset of the data, which may be determined through a pre-processing method) to determine a control output using any algorithm and/or data processing technique. In various examples, the data analysis module 156 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms may include computer-executable code that may be retrieved by the computing system 132 and may be used to generate subsequent instructions 142.

In some examples, the data analysis module 156 may receive the input data from one or more input devices 134. In turn, the system 130 may determine a position of the latch actuator 94, which, in turn, controls a position of the first strike plate 88A and/or the second strike plate 88B.

Referring still to FIG. 7, the instructions 142 stored within the memory 138 of the computing system 132 may also be executed by the processors 136 to implement a control module 158. In general, the control module 158 may be configured to adjust the operation of the vehicle 10 by controlling one or more components of the vehicle 10. In several examples, the control module 158 may be configured to control the latch system 86 by transmitting respective control commands to actuate the latch actuator 94 to a defined position.

In several examples, the computing system 132 may also automatically control the operation of the user interface 24 to provide an operator notification associated with the position of the first strike plate 88A and/or the position of the second strike plate 88B. For instance, in some examples, the computing system 132 may control the operation of the user interface 24 in a manner that causes data associated with the position of the first strike plate 88A and/or the position of the second strike plate 88B to be presented to the operator of the vehicle 10 to be presented to a user through numerical values, graphs, maps, and/or any other suitable visual indicators.

Moreover, as shown in FIG. 7, the computing system 132 may also include a communications interface 160 to communicate with any of the various other system components described herein. For instance, one or more communicative links or interfaces (e.g., one or more data buses and/or wireless connections) may be provided between the communications interface 160 and the input devices 134 to allow data transmitted from the input devices 134 to be received by the computing system 132. Additionally, as shown in FIG. 7, one or more communicative links or interfaces (e.g., one or more data buses and/or wireless connections) may be provided between the communications interface 160 and the latch system 86 to control the operation of such system components.

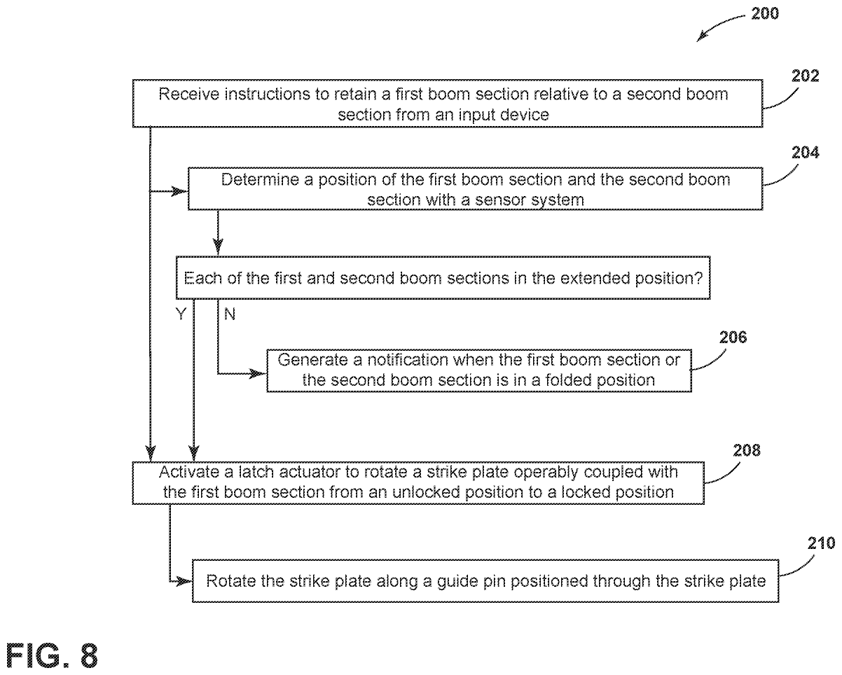

Referring now to FIG. 8, a flow diagram of some examples of a method 200 for an operation of a system for a boom assembly is illustrated in accordance with aspects of the present subject matter. In general, the method 200 will be described herein with reference to the vehicle 10 and the system 130 described above with reference to FIGS. 1-7. However, the disclosed method 200 may generally be utilized with any suitable vehicle 10 and/or may be utilized in connection with a system having any other suitable system configuration. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein may be omitted, rearranged, combined, and/or adapted in various ways without deviating from the scope of the present disclosure.

As shown in FIG. 8, at (202), the method 200 may include receiving instructions to retain a first boom section relative to a second boom section from an input device. As provided herein, the input devices may include a sensor system, which may include one or more sensors configured to monitor a position of the first boom section and/or the second boom section (or any other data), one or more positioning device(s) for generating position data associated with the location of the vehicle, one or more user interfaces for allowing operator inputs to be provided to the computing system (e.g., buttons, knobs, dials, levers, joysticks, touch screens, and/or the like), one or more other internal data sources 150 associated with the vehicle (e.g., other devices, databases, etc.), one or more external data sources (e.g., a remote computing device or server), and/or any other suitable input devices.

At (204), the method 200 may include determining a position of the first boom section and the second boom section with a sensor system. If the first boom section or the second boom section is not in the extended position, the method, at (206), may include generating a notification when the first boom section or the second boom section is in a folded position. If the first boom section and the second boom section are in the extended position, at (208), the method may include activating a latch actuator to rotate a strike plate operably coupled with the first boom section from an unlocked position to a locked position with a computing system. In some instances, the strike plate may interact with a catch on the second boom section in the locked position. In various examples, the latch actuator may be operably coupled with a link assembly. The link assembly may include a position plate rotatably coupled with a brace, a first link operably coupled with the position plate and the first strike plate, and a latch actuator link operably coupled with the latch actuator and the position plate. In some cases, a rotational axis of the strike plate is offset from a rotational axis of the position plate. At (210), the method 200 may include rotating the strike plate along a guide pin positioned through the strike plate.

In various examples, the method 200 may implement machine learning methods and algorithms that utilize one or several vehicle learning techniques including, for example, decision tree learning, including, for example, random forest or conditional inference trees methods, neural networks, support vector machines, clustering, and Bayesian networks. These algorithms may include computer-executable code that may be retrieved by the computing system and/or through a network/cloud and may be used to evaluate and update the adjustment model. In some instances, the vehicle learning engine may allow for changes to the adjustment model to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for a boom assembly comprising:
a first strike plate operably coupled with a first boom section, the first strike plate rotatable between a first position and a second position;
a first catch operably coupled with a second boom section, wherein the first strike plate is free of the first catch when the first strike plate is in the first position to define an unlocked position and the first strike plate interacts with the first catch when the first strike plate is in the second position to define a locked position, and wherein the first boom section and the second boom section are movable relative to one another; and
a brace operably coupled with the first boom section and the first strike plate.

2. The system of claim 1, further comprising:
a latch actuator operably coupled with the first strike plate and configured to rotate the first strike plate between the first position and the second position.

3. The system of claim 2, further comprising:
a link assembly operably coupled with the latch actuator and the first strike plate, the link assembly including a position plate rotatably coupled with an anchor portion of the brace.

4. The system of claim 3, wherein the link assembly further comprises:
a first link operably coupled with the position plate and the first strike plate.

5. The system of claim 3, wherein the link assembly further comprises:
a latch actuator link operably coupled with the latch actuator and the position plate.

6. The system of claim 5, further comprising:
a second strike plate operably coupled with the first boom section, the second strike plate rotatable between a first position and a second position; and
a second catch operably coupled with a second boom section, wherein the second strike plate is free of the second catch when the second strike plate is in the first position to define an unlocked position and the second strike plate interacts with the second catch when the second strike plate is in the second position to define a locked position.

7. The system of claim 6, wherein the first strike plate is positioned on a first side of an end panel of the second boom section and the second strike plate is positioned on a second, opposing side of the end panel of the second boom section.

8. The system of claim 6, wherein the link assembly further comprises:
a second link operably coupled with the position plate and the second strike plate.

9. The system of claim 1, wherein the first strike plate is pivotably coupled with the brace through a pivot pin.

10. The system of claim 1, further comprising:
a guide pin positioned through a channel defined by the first strike plate and into a guide opening of the brace to guide the first strike plate as the first strike plate is moved between the first position and the second position.

11. A method for an operation of a system for a boom assembly, the method comprising:
receiving, from an input device, instructions to retain a first boom section relative to a second boom section; and
activating, with a computing system, a latch actuator to rotate a strike plate operably coupled with the first boom section from an unlocked position to a locked position, wherein the strike plate interacts with a catch on the second boom section in the locked position.

12. The method of claim 11, further comprising:
determining, with a sensor system, a position of the first boom section and the second boom section.

13. The method of claim 12, wherein the strike plate is rotated from the unlocked and the locked position when each of the first boom section and the second boom section are positioned in an extended position, and wherein the computing system generates a notification when the first boom section or the second boom section is in a folded position.

14. The method of claim 12, wherein the latch actuator is operably coupled with a link assembly, the link assembly comprising:
a position plate rotatably coupled with a brace;
a first link operably coupled with the position plate and the strike plate; and
a latch actuator link operably coupled with the latch actuator and the position plate.

15. The method of claim 14, wherein a rotational axis of the strike plate is offset from a rotational axis of the position plate.

16. The method of claim 13, further comprising:
rotating the strike plate along a guide pin positioned through the strike plate.

17. A system for a boom assembly comprising:
a first strike plate operably coupled with a first boom section, the first strike plate rotatable between a first position and a second position;
a first catch operably coupled with a second boom section, the first strike plate configured to interact with the first catch when the first strike plate is in the second position;
a second strike plate operably coupled with the first boom section, the second strike plate rotatable between a first position and a second position; and
a second catch operably coupled with a second boom section, the second strike plate configured to interact with the second catch when the second strike plate is in the second position.

18. The system of claim 17, further comprising:
a brace defining a first strike plate portion, a second strike plate portion, and an anchor portion; and
a position plate rotatably coupled with the anchor portion.

19. The system of claim 18, further comprising:
a latch actuator operably coupled with the position plate and configured to rotate the position plate relative to the brace.

20. The system of claim 19, further comprising:
a link assembly comprising:
a latch actuator link operably coupled with the latch actuator and the position plate;
a first link operably coupled with the position plate and the first strike plate; and
a second link operably coupled with the position plate and the second strike plate.
